(19) United States
(12) Patent Application Publication
(10) Pub. No.: US 2022/0078637 A1
(43) Pub. Date: Mar. 10, 2022

(54) WIRELESS DEVICE, A NETWORK NODE AND METHODS THEREIN FOR UPDATING A FIRST INSTANCE OF A MACHINE LEARNING MODEL

(71) Applicant: Telefonaktiebolaget LM Ericsson (publ), Stockholm (SE)

(72) Inventors: Hugo TULLBERG, Nyköping (SE); Johan OTTERSTEN, Stockholm (SE)

(21) Appl. No.: 17/415,200

(22) PCT Filed: Dec. 28, 2018
(86) PCT No.: PCT/SE2018/051374

§ 371 Date: Jun. 17, 2021

(51) Int. Cl. H04W 24/02; G06N 20/00; H04L 12/24; H04W 24/08

(52) U.S. Cl. CPC H04W 24/02; H04W 24/08; H04L 41/16; G06N 20/00

(57) ABSTRACT

A network node (NN) and method therein for assisting a wireless device (UE) in updating a first instance of a machine learning model. The NN has a second instance of the model. The NN receives, from the UE, information relating to a prediction of an operation and to a result of the operation. The prediction of the operation is obtained by means of the first instance and the operation relates to a transmission over the communications interface. The NN updates one or more parameters of the second instance based on the received information. The NN transmits, to the UE, information relating to the updated parameters when a model difference between a prediction of the operation obtained by the second instance which includes the updated parameters and the prediction of the operation obtained by means of the first instance is indicative of a need of updating the first instance.

### TECHNICAL FIELD

Embodiments herein relate generally to a wireless device, a network node and to methods therein. In particular, embodiments relate to updating of first instance of a machine learning model.

### BACKGROUND

In a typical wireless communication network, communications devices, also known as wireless communication devices, wireless devices, mobile stations, stations (STA) and/or User Equipments (UEs), communicate via a Local Area Network such as a WiFi network or a Radio Access Network (RAN) to one or more Core Networks (CN). The RAN covers a geographical area which is divided into service areas or cell areas, which may also be referred to as a beam or a beam group, with each service area or cell area being served by a Radio Network Node (RNN) such as a radio access node e.g., a Wi-Fi access point or a Radio Base Station (RBS), which in some networks may also be denoted, for example, a NodeB, eNodeB (eNB), or gNB as denoted in 5G. A service area or cell area is an area, e.g. a geographical area, where radio coverage is provided by the radio network node. The radio network node communicates over an air interface operating on radio frequencies with the communications device within range of the radio network node.

Specifications for the Evolved Packet System (EPS), also called a Fourth Generation (4G) network, have been completed within the 3rd Generation Partnership Project (3GPP) and this work continues in the coming 3GPP releases, for example to specify a Fifth Generation (5G) network also referred to as 5G New Radio (NR). The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access network wherein the radio network nodes are directly connected to the EPC core network rather than to RNCs used in 3G networks. In general, in E-UTRAN/LTE the functions of a 3G RNC are distributed between the radio network nodes, e.g. eNodeBs in LTE, and the core network. As such, the RAN of an EPS has an essentially “flat” architecture comprising radio network nodes connected directly to one or more core networks, i.e. they are not connected to RNCs. To compensate for that, the E-UTRAN specification defines a direct interface between the radio network nodes, this interface being denoted the X2 interface.

Multi-antenna techniques used in Advanced Antenna Systems (AAS) can significantly increase the data rates and reliability of a wireless communication system. The performance is in particular improved if both the transmitter and the receiver are equipped with multiple antennas, which results in a Multiple-Input Multiple-Output (MIMO) communication channel. Such systems and/or related techniques are commonly referred to as MIMO systems.

Machine Learning (ML) will become an important part of current and future wireless communications networks and systems. In this disclosure the terms machine learning and ML may be used interchangeably. Recently, machine learning has been used in many different communication applications and shown great potential. As ML becomes increasingly utilized and integrated in the communications system, a structured architecture is needed for communicating ML information between different nodes operating in the communications system. Some examples of such nodes are wireless devices, radio network nodes, core network nodes, computer cloud nodes just to give some examples. Usage of the communications system and the realization of the communications system, including the radio communication interface, the network architecture, interfaces and protocols will change when Machine Intelligence (MI) capabilities are ubiquitously available to all types of nodes in and end-users of a wireless communication system. In this disclosure the terms machine intelligence and MI may be used interchangeably.

In general, the term Artificial Intelligence (AI) comprises reasoning, knowledge representation, planning, learning, natural language processing, perception and the ability to move and manipulate objects. Hence Machine Learning (ML) is sometimes considered as a subfield of AI. In this disclosure, the term Machine Intelligence (MI) is used to comprise both AI and ML. Further, in this disclosure the terms AI, MI and ML may be used interchangeably.

### SUMMARY

As part of developing embodiments herein, some drawbacks with the state of the art communications system will first be identified and discussed.

In common machine learning systems the training phase and the prediction phase are either kept together in a node capable of machine learning, or distributed to nodes that are less capable of machine learning and that use a fixed machine learning model. A drawback with having both the training phase and the prediction phase in the same node is that the node must be able to perform both training of the machine training model and predictions using the machine learning model which requires a certain amount of processing and/or storing capabilities. In a wireless communications system, some nodes such as wireless devices, e.g. sensors, may not have the required amount of processing and/or storing capabilities for performing both training and predictions. If such a wireless device is provided with a fixed machine learning model, the predictions made will not be accurate once changes in the communications system or in the performance of the wireless device occur since the machine learning model is not updated to take such changes into account.

Some embodiments disclosed herein enables training of a machine learning model at a network node that is located remotely from a wireless device that is using the machine learning model to perform predictions. The wireless device may have limited machine learning capabilities and thus it may be unable to perform training of the machine learning model itself but the machine learning model may be trained by the network node having more machine learning capabilities. In this case, the wireless device needs to transmit relevant training data to the network node.

By the expression “network node with more ML capabilities” when used in this disclosure is meant a network node that have sufficient processing and storing capabilities to perform machine learning, e.g. more ML capabilities than the wireless device. For example, the network node with more ML capabilities is a network node having capability of doing the ML inference, e.g. capability to use a trained machine learning model to perform a prediction and of doing the machine learning ML training, e.g. the capability to update the ML models parameters based on training data. A network node having limited machine learning capabilities has not sufficient processing and storing capabilities to perform machine learning, it has only the interference capability, e.g. the capability to use a trained machine learning model to perform a prediction. Such a network node may for example be the wireless device.

According to developments of wireless communications systems, an improved usage of resources in the wireless communications system is needed for improving the performance of the wireless communications system.

Therefore, an object of embodiments herein is to overcome the above-mentioned drawbacks among others and to improve the performance in a wireless communications system.

According to an aspect of embodiments herein, the object is achieved by a method performed in a network node for assisting a wireless device in updating a first instance of a machine learning model relating to the wireless device. The network node and the wireless device are communicating over a communications interface in a wireless communications system. The network node has a second instance of the machine learning model relating to the wireless device.

The network node receives information from the wireless device. The information relates to at least one prediction of an operation of the wireless device and to at least one result of the operation. The at least one prediction of the operation is obtained by means of the first instance of the machine learning model, and the operation is relating to a transmission over the communications interface.

The network node then updates one or more parameters of the second instance of the machine learning model based on the received information.

Further, the network node transmits information relating to the updated one or more parameters of the second instance of the machine learning model to the wireless device, This is transmitted when a model difference between a prediction of the operation obtained by the second instance of the machine learning model comprising the updated one or more parameters and the prediction of the operation obtained by means of the first instance of the machine learning model is indicative of a need of updating the first instance of the machine learning model.

According to another aspect of embodiments herein, the object is achieved by a network node for assisting a wireless device in updating a first instance of a machine learning model relating to the wireless device. The network node and the wireless device are configured to communicate over a communications interface in a wireless communications system and the network node has a second instance of the machine learning model relating to the wireless device.

The network node is configured to receive, from the wireless device, information relating to at least one prediction of an operation of the wireless device and to at least one result of the operation. The at least one prediction of the operation is obtained by means of the first instance of the machine learning model, and the operation is relating to a transmission over the communications interface.

Further, the network node is configured to update one or more parameters of the second instance of the machine learning model based on the received information.

Furthermore, the network node is configured to transmit, to the wireless device, information relating to the updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model.

According to another aspect of embodiments herein, the object is achieved by a method performed in a wireless device for updating a first instance of a machine learning model relating to the wireless device. The wireless device and a network node having a second instance of the machine learning model are communicating over a communications interface in a wireless communications system.

The wireless device transmits, to the network node, information relating to at least one prediction of an operation of the wireless device and to at least one result of the operation. The at least one prediction of the operation is obtained by means of the first instance of the machine learning model and the operation is relating to a transmission over the communications interface.

Further, the wireless device receives, from the network node, information relating to updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model.

Furthermore, the wireless device updates one or more parameters of the first instance of the machine learning model based on the received information.

According to another aspect of embodiments herein, the object is achieved by a wireless device for updating a first instance of a machine learning model relating to the wireless device. The wireless device and a network node having a second instance of the machine learning model are configured to communicate over a communications interface in a wireless communications system.

The wireless device is configured to transmit, to the network node, information relating to at least one prediction of an operation of the wireless device and to at least one result of the operation. The at least one prediction of the operation is obtained by means of the first instance of the machine learning model and the operation is relating to a transmission over the communications interface.

Further, the wireless device is configured to receive, from the network node, information relating to updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model.

Furthermore, the wireless device is configured to update one or more parameters of the first instance of the machine learning model based on the received information.

According to another aspect of embodiments herein, the object is achieved by a computer program, comprising instructions which, when executed on at least one processor, causes the at least one processor to carry out the method performed by the network node.

According to another aspect of embodiments herein, the object is achieved by a computer program, comprising instructions which, when executed on at least one processor, causes the at least one processor to carry out the method performed by the wireless device.

According to another aspect of embodiments herein, the object is achieved by a carrier comprising the computer program, wherein the carrier is one of an electronic signal, an optical signal, a radio signal or a computer readable storage medium.

The network node only transmits information relating to the updated one or more parameters of the second instance of the machine learning model to the wireless device when a model difference between a prediction of the operation obtained by the second instance of the machine learning model and the prediction of the operation obtained by means of the first instance of the machine learning model is indicative of a need of updating the first instance of the machine learning model. This results in that transmissions relating to minor changes of the second instance of the machine learning model in relation to the first instance of the machine learning model will be avoided, thereby reducing or avoiding interference with ongoing user communications over the communication interface by such transmissions. Therefore, a more efficient use of the radio spectrum is provided. This results in an improved performance in the wireless communications system.

An advantage with some embodiments herein is that they provide for remote training of training of a machine learning models, thereby separating the inference (prediction) and training phases of machine learning models.

Another advantage with some embodiments herein is that they enable the wireless device to use the inference, i.e. forward pass, for predictions.

Another advantage with some embodiments is that, since the training and inference phases are performed in different network nodes, different numerical precision may be used for the training and the inference, respectively. For example, a higher precision may be used in the training phase and a lower precision may be used in the inference phase to balance complexity and speed.

### BRIEF DESCRIPTION OF DRAWINGS

Examples of embodiments herein will be described in more detail with reference to attached drawings in which:

FIG. 1 is a schematic block diagram illustrating embodiments of a wireless communications system;

FIG. 2 is a flowchart depicting embodiments of a method performed by a network node;

FIG. 3 is a schematic block diagram illustrating embodiments of a network node;

FIG. 4 is a flowchart depicting embodiments of a method performed by a wireless device;

FIG. 5 is a schematic block diagram illustrating embodiments of a wireless device;

FIG. 6 schematically illustrates an example machine learning model as a neural network;

FIG. 7 schematically illustrates embodiments comprising separated inference and training phases;

FIG. 8 is a combined flowchart and signalling scheme schematically illustrating embodiments of a method performed in a wireless communications system;

FIG. 9 is a flowchart depicting embodiments of a method performed by the network node;

FIG. 10 is a flowchart depicting embodiments of a method performed by the wireless device; and

FIGS. 11 to 16 are flowcharts illustrating methods implemented in a communication system including a host computer, a base station and a user equipment.

### DETAILED DESCRIPTION

The machine intelligence according to embodiments herein, should not be considered as an additional layer on top of the communication system, but rather the opposite—the communication in the communications system takes place to allow distribution of the machine intelligence. The end-user, e.g. a wireless device, interacting with a distributed machine intelligence will achieve whatever it is the wireless device wants to achieve. The wireless device may have access to different ML models for different purposes. For example, one purpose may be to predict relevant information about a communication link to reduce the need for measurements and therefore decreasing complexity and overhead in the communications system comprising the communication link. Distributed storage and compute power is included—ever-present, but not infinite.

Machine learning (ML) will become an important part of current and future system. Recently, it has been used in many different communication applications and shown great potential. Embodiments herein provide a method that makes a wireless communications network capable of handling data-driven solutions. The ML according to embodiments herein may be performed everywhere in the wireless communications system based on data generated everywhere.

Throughout the following description similar reference numerals may be used to denote similar elements, units, modules, circuits, nodes, parts, items or features, when applicable. In the Figures, features that appear only in some embodiments are typically indicated by dashed lines.

In the following, embodiments herein are illustrated by exemplary embodiments. It should be noted that these embodiments are not mutually exclusive. Components from one embodiment may be tacitly assumed to be present in another embodiment and it will be obvious to a person skilled in the art how those components may be used in the other exemplary embodiments.

According to embodiments herein, it is provided a way of improving the performance in the wireless communications system by e.g. improving usage of resources in the wireless communications system. However, even if some embodiments described herein relate to improved resource utilization it should be understood that some embodiments disclosed herein, alternatively or additionally, may provide an improved flexibility and/or an improved adaptability.

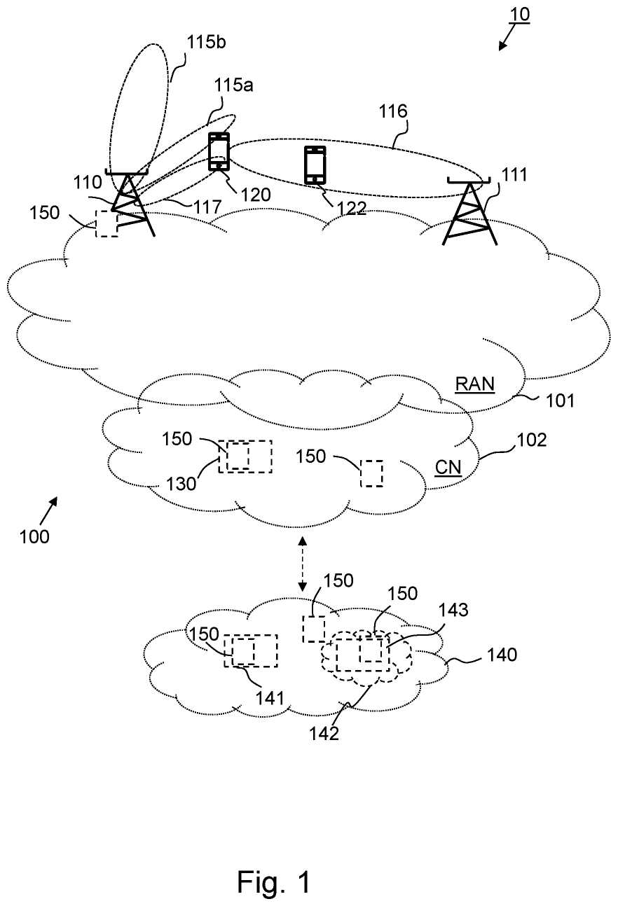

FIG. 1 is a schematic block diagram schematically depicting an example of a wireless communications system 10 that is relevant for embodiments herein and in which embodiments herein may be implemented.

A wireless communications network 100 is comprised in the wireless communications system 10. The wireless communications network 100 may comprise a Radio Access Network (RAN) 101 part and a Core Network (CN) 102 part. The wireless communication network 100 is typically a telecommunication network, such as a cellular communication network that supports at least one Radio Access Technology (RAT), e.g. New Radio (NR) that also may be referred to as 5G. The RAN 101 is sometimes in this disclosure referred to as an intelligent RAN (iRAN). By the expression “intelligent RAN (IRAN)” when used in this disclosure is meant a RAN comprising and/or providing machine intelligence, e.g. by means of a device that perceives its environment and takes actions that maximize its chance of successfully achieving its goals. The machine intelligence may be provided by means of a machine learning unit as will be described below. Thus, the iRAN is a RAN that e.g. has the AI capabilities described in this disclosure.

The wireless communication network 100 comprises network nodes that are communicatively interconnected. The network nodes may be logical and/or physical and are located in one or more physical devices. The wireless communication network 100 comprises one or more network nodes, e.g. a radio network node 110, such as a first radio network node, and a second radio network node 111. A radio network node is a network node typically comprised in a RAN, such as the RAN 101, and/or that is or comprises a radio transmitting network node, such as a base station, and/or that is or comprises a controlling node that controls one or more radio transmitting network nodes.

The wireless communication network 100, or specifically one or more network nodes thereof, e.g. the first radio network node 110 and the second radio network node 111, may be configured to serve and/or control and/or manage and/or communicate with one or more communication devices, such as a wireless device 120, using one or more beams, e.g. a downlink beam 115a and/or a downlink beam 115b and/or a downlink beam 116 provided by the wireless communication network 100, e.g. the first radio network node 110 and/or the second radio network node 111, for communication with said one or more communication devices. Said one or more communication devices may provide uplink beams, respectively, e.g. the wireless device 120 may provide an uplink beam 117 for communication with the wireless communication network 100.

Each beam may be associated with a particular Radio Access Technology (RAT). As should be recognized by the skilled person, a beam is associated with a more dynamic and relatively narrow and directional radio coverage compared to a conventional cell that is typically omnidirectional and/or provides more static radio coverage. A beam is typically formed and/or generated by beamforming and/or is dynamically adapted based on one or more recipients of the beam, such as one of more characteristics of the recipients, e.g. based on which direction a recipient is located. For example, the downlink beam 115a may be provided based on where the wireless device 120 is located and the uplink beam 117 may be provided based on where the first radio network node 110 is located.

The wireless device 120 may be a mobile station, a non-access point (non-AP) STA, a STA, a user equipment and/or a wireless terminals, an Internet of Things (IoT) device, a Narrow band IoT (NB-IoT) device, an eMTC device, a CAT-M device, an MBB device, a WiFi device, an LTE device and an NR device communicate via one or more Access Networks (AN), e.g. RAN, to one or more core networks (CN). It should be understood by the skilled in the art that “wireless device” is a non-limiting term which means any terminal, wireless communication terminal, user equipment, Device to Device (D2D) terminal, or node e.g. smart phone, laptop, mobile phone, sensor, relay, mobile tablets or even a small base station communicating within a cell.

Moreover, the wireless communication network 100 may comprise one or more central nodes, e.g. a central node 130 i.e. one or more network nodes that are common or central and communicatively connected to multiple other nodes, e.g. multiple radio network nodes, and may be configured for managing and/or controlling these nodes. The central nodes may e.g. be core network nodes, i.e. network nodes part of the CN 102.

The wireless communication network, e.g. the CN 102, may further be communicatively connected to, and thereby e.g. provide access for said communication devices, to an external network 140, e.g. the Internet. The wireless device 120 may thus communicate via the wireless communication network 100, with the external network 140, or rather with one or more other devices, e.g. servers and/or other communication devices connected to other wireless communication networks, and that are connected with access to the external network 140.

Moreover, there may be one or more external nodes, e.g. an external node 141, for communication with the wireless communication network 100 and node(s) thereof. The external node 141 may e.g. be an external management node. Such external node may be comprised in the external network 140 or may be separate from this.

Furthermore, the one or more external nodes may correspond to or be comprised in a so called computer, or computing, cloud, that also may be referred to as a cloud system of servers or computers, or simply be named a cloud, such as a computer cloud 142, for providing certain service(s) to outside the cloud via a communication interface. In such embodiments, the external node may be referred to as a cloud node or cloud network node 143. The exact configuration of nodes etc. comprised in the cloud in order to provide said service(s) may not be known outside the cloud. The name “cloud” is often explained as a metaphor relating to that the actual device(s) or network element(s) providing the services are typically invisible for a user of the provided service(s), such as if obscured by a cloud. The computer cloud 142, or typically rather one or more nodes thereof, may be communicatively connected to the wireless communication network 100, or certain nodes thereof, and may be providing one or more services that e.g. may provide, or facilitate, certain functions or functionality of the wireless communication network 100 and may e.g. be involved in performing one or more actions according to embodiments herein. The computer cloud 203 may be comprised in the external network 140 or may be separate from this.

One or more higher layers of the communications network and corresponding protocols are well suited for cloud implementation. By the expression higher layer when used in this disclosure is meant an OSI layer, such as an application layer, a presentation layer or a session layer. The central layers, e.g. the higher levels, of the iRAN architecture are assumed to have wide or global reach and thus expected to be implemented in the cloud.

One advantage of a centralised implementation, such as a cloud implementation, is that data may be shared between different machine learning models, e.g. between machine learning models for different communications links. This may allow for a faster training mode by establishing a common model based on all available input. During a prediction mode, separate machine learning models may be used for each site or communications link. The machine learning model corresponding to a particular site or communications link may be updated based on data, such as ACK/NACK, from that site. Thereby, machine learning models optimized to the specific characteristic of the site are obtained.

By the term “site” when used in this disclosure is meant a location of a device radio network node, e.g. the first and/or the second radio network node 110,111.

Another advantage with a centralised implementation, such as a cloud implementation, is that one or more of the machine learning functions described herein to be performed in the network node 110 may be moved to a the cloud and to performed by the cloud network node 143.

Another advantage with centralised implementation, wherein the training is moved to a centralised node such as a cloud node, is that the amount of training error data may be increased since several wireless devices may send their respective training error data to one and the same centralised node. A more centralized location may also get data from more environment types and create better models, weights, for the different types. Centralizing training may also simplify the handling of weight version, since a large number of similar models may be avoided as compared to the case with local training. For example, if the model update is done locally and each new version is given a separate version number, then there may be many models that only have minor differences. A centralized node may either train on all the data from similar environments and make one model update instead of many that only differs slightly or take the separate models and create an “average” model from them.

In a centralised implementation, the machine learning functions shown to be performed in the network node 110 is moved to the central network node 130 or to the cloud network node 143.

It should be understood that functions for user communication, such as payload communication, may be collocated with functions for ML communication but it should be understood that they don't have to be collocated.

One or more machine learning units 150 are comprised in the wireless communications system 10. Thus, it should be understood that the machine learning unit 150 may be comprised in the wireless communications network 100 and/or in the external network 140. For example, the machine learning unit 150 may be a separate unit operating within the wireless communications network 100 and/or the external network 140 and/or it may be comprised in a node operating within the wireless communications network 100 and/or the external network 140. In some embodiments, a machine learning unit 150 is comprised in the radio network node 110. Additionally or alternatively, the machine learning unit 150 may be comprised in the core network 102, such as e.g. in the central node 130, or it may be comprised in the external node 141 or in the computer cloud 142 of the external network 140.

Attention is drawn to that FIG. 1 is only schematic and for exemplifying purpose and that not everything shown in the figure may be required for all embodiments herein, as should be evident to the skilled person. AIso, a wireless communication network or networks that in reality correspond(s) to the wireless communication network 100 will typically comprise several further network nodes, such as core network nodes, e.g. base stations, radio network nodes, further beams, and/or cells etc., as realized by the skilled person, but which are not shown herein for the sake of simplifying.

Note that actions described in this disclosure may be taken in any suitable order and/or be carried out fully or partly overlapping in time when this is possible and suitable. Dotted lines attempt to illustrate features that may not be present in all embodiments.

Any of the actions below may when suitable fully or partly involve and/or be initiated and/or be triggered by another, e.g. external, entity or entities, such as device and/or system, than what is indicated below to carry out the actions. Such initiation may e.g. be triggered by said another entity in response to a request from e.g. the device and/or the wireless communication network, and/or in response to some event resulting from program code executing in said another entity or entities. Said another entity or entities may correspond to or be comprised in a so called computer cloud, or simply cloud, and/or communication with said another entity or entities may be accomplished by means of one or more cloud services.

Some embodiments disclosed herein relate to a method to reduce the amount of processing done locally at a wireless device 120 and/or to reduce exchange of large amounts of data between the wireless device 120 and a network node 110, 130, 143. This presents an alternative solution to the local storage idea.

A setup is when machine learning is used to make some selection of parameter setting. In a communication scenario, if the selection of parameter setting was bad, an error occurs. During training of a machine learning model, the output of the machine learning model is compared to a known target value. The target is a known value given from the outside and used for training. For example, the target value may be received from a manually designed receiver circuit or from an algorithm. The difference between the output of the machine learning model and the target value is used for training of the machine learning model. This difference is sometimes in this disclosure referred to as training difference.

In some embodiments, the wireless device 120 performs the inference, i.e. the prediction, using a first instance of the machine learning model. For example, the wireless device 120 performs the prediction by performing a forward propagation in case of a neural network. However, instead of using the training difference, if any, to train the first instance of the machine learning model, the training differences are stored at the wireless device 120. This may be performed either individually, storage permitting, or accumulated. The wireless device 120 transmits the training differences are transmitted to the network node 110, 130, 143 or another network entity capable of training of a machine learning model.

The network node 110, 130, 143, which may be a cloud entity, keeps a second instance of the machine learning model used in the wireless device 120. On reception of the one or more training differences, the network node 110, 130, 143 trains the second instance of the machine learning model based on the received one or more training differences. Information relating to the updated second instance of the machine learning model is then transmitted back to the wireless device 120, whereby the wireless device 120 may update the first instance of the machine learning model. AIternatively, if the machine learning model updates are below some threshold, the transmission of the information relating to the updated second instance of the machine learning model may be deferred until further updates to the second instance of the machine learning model have been done and the difference between the updated second instance of the machine learning model and the first instance of the machine learning model is sufficiently large.

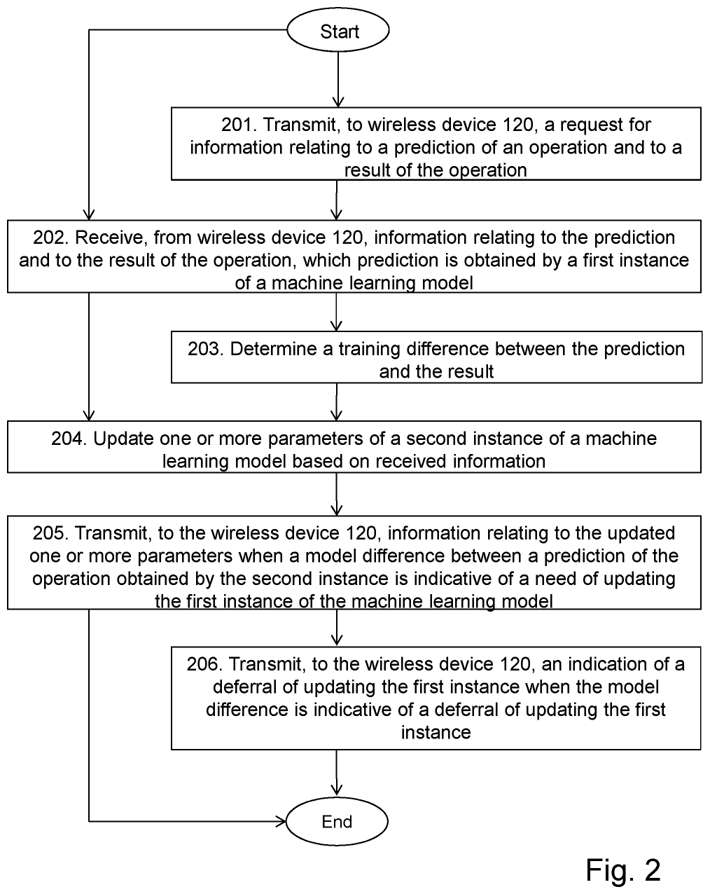

Examples of a method performed by the network node 110, 130, 143 for assisting the wireless device 120 in updating a first instance of a machine learning model relating to the wireless device 120 will now be described with reference to flowchart depicted in FIG. 2. As previously mentioned, the wireless device 120 and the network node 110, 130, 143 communicate over a communications interface in the wireless communications system 10. Further, the network node 110 has a second instance of the machine learning model. The machine leaning model relates to the wireless device 120. Thus, the machine learning model is a representation of the wireless device, one or more network nodes, e.g. the network node 110 operating in the communications system 10, and of one or more communications links between the wireless device 120 and the one or more network nodes. Further, the machine learning model may be a representation of one or more wireless devices, e.g. the wireless device 120, 122, and of one or more network nodes, e.g. the network node 110, 111, operating in the wireless communications system and of one or more communications links between the one or more wireless devices and the one or more network nodes. The machine learning model may comprise an input layer, an output layer and one or more hidden layers, wherein each layer comprises one or more artificial neurons linked to one or more other artificial neurons of the same layer or of another layer; wherein each artificial neuron has an activation function, an input weighting coefficient, a bias and an output weighting coefficient, and wherein the weighting coefficients and the bias are changeable during training of the machine learning model.

The first and second instances of the machine learning model are two versions of the same machine learning model. For example, at the onset, the first and second instances of the machine learning model may be identical, but during machine learning performed in the network node 110 as will be described below, the network node 110 may update its version of the machine learning model, i.e. the second instance of the machine learning model. Based on the machine learning performed by the network node 110, the network node 110 may inform the wireless device 120 about one or more parameters that have been updated in the second instance of the machine learning model. When in receipt of such information, the wireless device 120 may update its version of the machine learning model, i.e. the first instance of the machine learning model. However as will be describe below, the first instance of the machine learning model is not updated by the wireless device 120 every time the network node 110 updates the second instance of the machine learning model.

Sometimes in this disclosure, communication of information or parameters relating to the one or more instances of one or more machine learning models is referred to as Machine Learning (ML) communication. It should be understood that the ML communication is different from other communication in the communications system such as user communication comprising payload transmission.

The method comprises one or more of the following actions. It should be understood that these actions may be taken in any suitable order and that some actions may be combined.

Action 201

In order to be able to perform remote machine learning, the network node 110, 130, 143 may transmit a request for information relating to a prediction of at least one operation of the wireless device 120 and of at least one result of the operation to the wireless device 120. Thus, in some embodiments the network node 110, 130, 143 transmits a request to the wireless device 120. The request is for information relating to the at least one prediction of an operation of the wireless device 120 and to the at least one result of the operation. The operation is described more below, under Action 202.

It should be understood that the network node 110, 130, 143 may transmit such a request to several wireless devices.

The network node 110, 130, 143 may transmit the request when a period of time has expired, when a number of received user communications from the wireless device 120 is above a threshold value for the user communications; and/or when an error in the at least one prediction of the operation is expected.

Further, the network node 110, 130, 143 may transmit the request for the information when it expects that a change in performance of the wireless communications system 10 is significant, e.g. above a threshold value, and one or more parameters of the first and/or second instances may need to be updated. In other words, the network node 110, 130, 143 may transmit the request when system performance or other information indicates a significant difference in the prediction performance unless parameter update is performed.

Action 202

The network node 110, 130, 143 receives, from the wireless device 120, information relating to at least one prediction of an operation of the wireless device 120 and to at least one result of the operation.

The at least one prediction of the operation is obtained by means of the first instance of the machine learning model. The at least one prediction of the operation may be obtained or determined by the wireless device 120 by means of the first instance of the machine learning model. Further, the at least one result of the operation may be obtained or determined by the wireless device 120 by performing the operation.

Further, the operation is relating to a transmission over the communications interface. For example, the operation may be a beam operation such as an operation to change transmit beam and/or receive beam for a transmission to be transmitted or received by the wireless device 120. As another example, the operation may be a handover operation or cell selection operation such as an operation to initiate a handover or a cell selection procedure. As a further example, the operation may be a selection of modulation and coding scheme. As yet a further example, the operation may be a decision to defer the transmission until an improvement in SNR occurs or some timer expires.

In some embodiments, the information relating to the at least one prediction of the operation of the wireless device 120 and to the at least one result of the operation comprises the prediction, e.g. an output of the first instance of the machine learning model, and the result, i.e. a true value which is obtained after performing the operation. Thus, in some embodiments, the received information comprises two values or parameters.

In some other embodiments, the information relating to the at least one prediction of the operation of the wireless device 120 and to the at least one result of the operation comprises a difference between the prediction and the result. Thus, in some other embodiments, the received information comprises the difference, e.g. a single value or parameter. The difference is sometimes referred to as an “error”.

In some embodiments, wherein the network node 110, 130, 143 has transmitted a request for information as described in Action 201 above, the network node 110, 130, 143 may receive, from the wireless device 120, the information in response to the transmitted request. It should be understood that in case the network node 110, 130, 143 has transmitted the request to several wireless devices, the network node 110, 130, 143 may receive information from one or more out of the several wireless devices, and this received information may be used in Actions 203 to determine a training difference and in Action 204 to update one or more parameters of the second instance of the machine learning model as described below.

Action 203

In some embodiments and based on the received information relating to the at least one prediction of the operation of the wireless device 120 and to the at least one result of the operation, the network node 110, 130, 143 determines a training difference between the at least one prediction of the operation of the wireless device 120 and the at least one result of the operation.

As mentioned above and in some embodiments, the information relating to the at least one prediction of the operation of the wireless device 120 and to the at least one result of the operation comprises the prediction, e.g. an output of the first instance of the machine learning model, and the result, i.e. a true value which is obtained after performing the operation. Thus, in some embodiments, the received information comprises two values or parameters. In such embodiments, the training difference is the difference between the two received values or parameters.

As also mentioned above and in some other embodiments, the information relating to the at least one prediction of the operation of the wireless device 120 and to the at least one result of the operation comprises a difference between the prediction and the result. Thus, in some other embodiments, the received information comprises the difference, e.g. a single value or parameter. In such embodiments, the training difference is the difference comprised in the received information.

The training difference may sometimes in this disclosure be referred to as a second difference, and the terms may be used interchangeably.

Action 204

The network node 110, 130, 143 updates one or more parameters of the second instance of the machine learning model based on the received information. By updating the second instance of the machine learning model, a prediction of an operation made by the updated second instance of the machine learning model is the same as or almost the same as a result of the operation. Thus, by updating the second instance of the machine learning model, the network node 110,130,143 will perform better predictions about the operations to be performed so the predictions are the same or almost the same as the results of the operations when performed.

The one or more parameters may be different parameters depending on the kind of machine learning model.

For example, when the machine learning model is based on a neural network, the one or more parameters may be one or more weights in the neural network. In a neural network implementation, the one or more parameters may be one or more layers, one or more neurons per layer, and/or one or more activations functions of the neural network.

As another example, when the machine learning model is a tree model, e.g. a decision tree model, the one or more parameters may be decisions conditions in the tree model. A tree model is a predictive model wherein one goes from observations about an item (represented in the branches) to conclusions about the item's target value (represented in the leaves). Tree models where the target variable may take a discrete set of values are called classification trees; in these tree structures, leaves represent class labels and branches represent conjunctions of features that lead to those class labels. Decision trees where the target variable may take continuous values, such as real numbers, are called regression trees.

In some embodiments, wherein the network node 110, 130, 143 has determined the training difference as mentioned in Action 203 above, the network node 110, 130, 143 updates the one or more parameters of the second instance of the machine learning model based on the determined training difference.

Action 205

In order to inform the wireless device 120 about one or more parameters to be updated in the first instance of the machine learning model, the network node 110, 130, 143, transmits, to the wireless device 120, information relating to the updated one or more parameters of the second instance of the machine learning model. This is done when a model difference between a prediction of the operation obtained by the second instance of the machine learning model comprising the updated one or more parameters and the prediction of the operation obtained by means of the first instance of the machine learning model is indicative of a need of updating the first instance of the machine learning model.

Thus, when the model difference indicates a need to update the first instance of the machine learning model, the network node transmits the information relating to the updated one or more parameters of the second instance to the wireless device 120.

The model difference may sometimes in this disclosure be referred to as a first difference, and the terms may be used interchangeably.

In some embodiments, the network node 110, 130, 143 transmits the information relating to the updated one or more parameters to the wireless device 120 when the determined model difference is above a threshold value for the model difference. Thus, the network node 110, 130, 143 only transmits the information relating to the updated one or more parameters when the model difference between the prediction of the operation obtained by the second instance comprising the updated one or more parameters and the prediction of the operation obtained by means of the first instance is determined to be significant. Consequently, the first instance of the machine learning model should be updated in order to improve the predictions made by the wireless device 120 using the first instance. Therefore, the network node 110, 130, 143 transmits the information relating to the updated one or more parameters to the wireless device 120, whereby the wireless device 120 may update the first instance of the machine learning model.

In some embodiments, when the model difference is above the threshold value for the model difference that is also indicative of a change in performance of the wireless communications system 10 being above a threshold value for the performance. In other words, when the model difference is significant, i.e. above the threshold value for the model difference, the performance of the wireless communications system 10 has changed significantly, i.e. the change in performance is above the threshold value for the performance.

The network node 110, 130, 143 may transmit, to the wireless device 120, the information relating to the updated one or more parameters when a load on a communications link between the network node 110, 130, 143 and the wireless device 120 is below a threshold value for the load. Thus, the network node 110, 130, 143 may for example defer from transmitting the information relating to the updated one or more parameters until ongoing user communications over the communications link is below a threshold value in order not to interfere with such ongoing user communication.

In some embodiments, the network node 110, 130, 143 transmits, to the wireless device 120, an indication of a deferral of updating the first instance of the machine learning model, when the model difference is indicative of a deferral of updating the first instance of the machine learning model. Such an indication will inform the wireless device 120 that the first instance of the machine learning model is good and that it does not have to be updated. By the expression “the first instance of the machine learning model is good” or similar is meant that the prediction of an operation made by the first instance of the machine learning model is the same as or almost the same as the result of the operation.

The network node 110, 130, 143 may transmit the indication of the deferral of updating the first instance of the machine learning model when the determined model difference is below the threshold value for the model difference.

AIternatively, the network node 110, 130, 143 may transmit the indication of the deferral of updating the first instance of the machine learning model when the model difference is indicative of a change in performance of the wireless communications system 10 being below the threshold value for the performance.

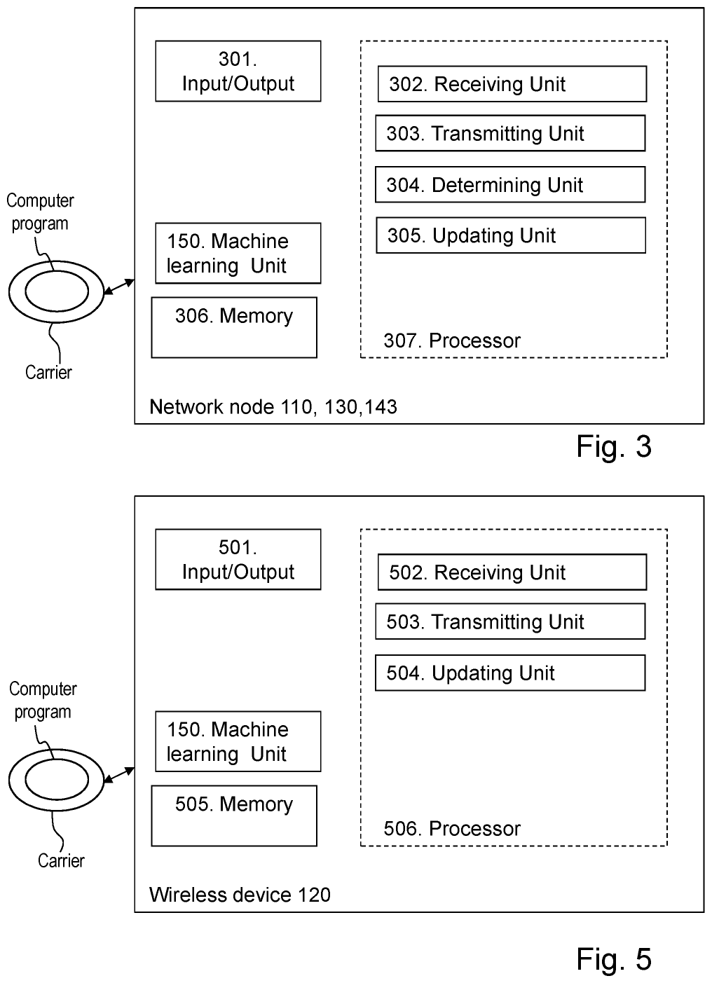

To perform the method for assisting the wireless device 120 in updating a first instance of a machine learning model, the network node 110, 130, 143 may comprise an arrangement depicted in FIG. 3. As previously mentioned, the wireless device 120 and the network node 110, 130, 143 communicate over a communications interface in the wireless communications system 10. Further, the network node 110, 130, 143 has a second instance of the machine learning model. The machine leaning model relates to the wireless device 120.

In some embodiments, the network node 110, 130, 143 comprises an input and/or output interface 301 configured to communicate with one or more other network nodes. The input and/or output interface 301 may comprise a wireless receiver (not shown) and a wireless transmitter (not shown).

The network node 110, 130, 143 is configured to receive, by means of a receiving unit 302 configured to receive, a transmission, e.g. a data packet, a signal or information, from a wireless device, e.g. the wireless device 120, from one or more network nodes, e.g. from the network node 111 and/or from one or more external node 141 and/or from one or more cloud node 143. The receiving unit 302 may be implemented by or arranged in communication with a processor 307 of the network node 110, 130, 143. The processor 307 will be described in more detail below.

The network node 110, 130, 143 is configured to receive, from the wireless device 120, information relating to at least one prediction of an operation of the wireless device 120 and to at least one result of the operation. The at least one prediction of the operation is obtained by means of the first instance of the machine learning model. As previously mentioned, the at least one prediction of the operation may be obtained or determined by the wireless device 120 by means of the first instance of the machine learning model. Further, the at least one result of the operation may be obtained or determined by the wireless device 120 by performing the operation.

Further, the operation is relating to a transmission over the communications interface. For example, and as previously mentioned, the operation may be a beam operation such as an operation to change transmit beam and/or receive beam for a transmission to be transmitted or received by the wireless device 120. As another example, the operation may be a handover operation or cell selection operation such as an operation to initiate a handover or a cell selection procedure. As a further example, the operation may be selection of modulation and coding scheme. As yet a further example, the operation may be a decision to defer the transmission until an improvement in SNR or some time has expired.

In some embodiments, the information relating to the at least one prediction of the operation of the wireless device 120 and to the at least one result of the operation comprises the prediction, e.g. an output of the first instance of the machine learning model, and the result, i.e. a true value which is obtained after performing the operation. Thus, in some embodiments, the received information comprises two values or parameters.

In some other embodiments, the information relating to the at least one prediction of the operation of the wireless device 120 and to the at least one result of the operation comprises a difference between the prediction and the result. Thus, in some other embodiments, the received information comprises the difference, e.g. a single value or parameter. The difference is sometimes referred to as an “error”.

In some embodiments, wherein the network node 110, 130, 143 has transmitted a request for information as described in Action 201 above, the network node 110, 130, 143 may be configured to receive, from the wireless device 120, the information in response to the transmitted request. It should be understood that in case the network node 110, 130, 143 has transmitted the request to several wireless devices, the network node 110, 130, 143 may be configured to receive information from one or more out of the several wireless devices, and this received information may be used to determine the training difference and to update one or more parameters of the second instance of the machine learning model as described below.

The network node 110, 130, 143 is configured to transmit, by means of a transmitting unit 303 configured to transmit, a transmission, e.g. a data packet, a signal or information, to another wireless device, e.g. the wireless device 122, to one or more network nodes, e.g. to the network node 110, 130, 143 and/or to one or more external node 141 and/or to one or more cloud node 143. The transmitting unit 303 may be implemented by or arranged in communication with the processor 307 of the network node 110, 130, 143.

In some embodiments, the network node 110, 130, 143 is configured to transmit, to the wireless device 120, a request for information relating to at least one prediction of an operation of the wireless device 120 and to at least one result of the operation.

As mentioned above, it should be understood that the network node 110, 130, 143 may transmit such a request to several wireless devices.

The network node 110, 130, 143 may be configured to transmit the request when a period of time has expired, when a number of received user communications from the wireless device 120 is above a threshold value for the user communications; and/or when an error in the at least one prediction of the operation is expected.

Further, the network node 110, 130, 143 may configured to transmit the request for the information when it expects that a change in performance of the wireless communications system 10 is significant, e.g. above a threshold value, and one or more parameters of the first and/or second instances may need to be updated. In other words, the network node 110, 130, 143 may be configured to transmit the request when system performance or other information indicates a significant difference in the prediction performance unless parameter update is performed.

The network node 110, 130, 143 may be configured to determine, by means of a determining unit 304 configured to determine, a difference between a prediction of an operation and a result of the operation. This difference is sometimes in this disclosure referred to as a training difference. The determining unit 304 may be implemented by or arranged in communication with the processor 307 of the network node 110, 130, 143.

In some embodiments and based on the received information relating to the at least one prediction of the operation of the wireless device 120 and to the at least one result of the operation, the network node 110, 130, 143 is configured to determine a training difference between the at least one prediction of the operation of the wireless device 120 and the at least one result of the operation.

As mentioned above and in some embodiments, the information relating to the at least one prediction of the operation of the wireless device 120 and to the at least one result of the operation comprises the prediction, e.g. an output of the first instance of the machine learning model, and the result, i.e. a true value which is obtained after performing the operation. Thus, in some embodiments, the received information comprises two values or parameters. In such embodiments, the training difference is the difference between the two received values or parameters.

As also mentioned above and in some other embodiments, the information relating to the at least one prediction of the operation of the wireless device 120 and to the at least one result of the operation comprises a difference between the prediction and the result. Thus, in some other embodiments, the received information comprises the difference, e.g. a single value or parameter. In such embodiments, the training difference is the difference comprised in the received information.

The training difference may sometimes in this disclosure be referred to as a second difference, and the terms may be used interchangeably.

The network node 110, 130, 143 is configured to update, by means of an updating unit 305 configured to update, one or more parameters of the second instance of the machine learning model. The updating module 305 may be implemented by or arranged in communication with the processor 307 of the network node 110, 130, 143.

The network node 110, 130, 143 is configured to update one or more parameters of the second instance of the machine learning model based on the received information.

As previously mentioned, the one or more parameters may be different parameters depending on the kind of machine learning model. For example, when the machine learning model is based on a neural network, the one or more parameters may be one or more weights in the neural network. In a neural network implementation, the one or more parameters may be one or more layers, one or more neurons per layer, and/or one or more activations functions of the neural network. As another example, when the machine learning model is a tree model, the one or more parameters may be decisions conditions in the tree model.

In some embodiments, wherein the network node 110, 130, 143 has determined the training difference, the network node 110, 130, 143 is configured to update the one or more parameters of the second instance of the machine learning model based on the determined training difference.

The training difference or training error is the difference between the known target for a specific input and the prediction, i.e. the output of the machine learning model for that same input. For a neural network, a common training algorithm is backpropagation, where each weight in the neural network is updated depending on how much that weight contributed to the training difference. The backpropagation algorithm is well known.

For decision trees, the decision values may be updated or the tree may be retrained completely. The decision tree is usually constructed top-down, and at each step the data set is split with respect to one feature/variable/input at a particular value such that the remaining uncertainty is minimized and the goodness is maximized. Examples of common metrics are Gini impurity, Information gain, and Variance reduction.

The network node 110, 130, 143 may, e.g. by means of the machine learning unit 150, be configured to train the second instance of the machine learning model based on the information received from the wireless device 120 and the determined training difference.

In some embodiments, the network node 110, 130, 143, e.g. by means of the machine learning unit 150, is configured to train the second instance of the machine learning model by adjusting one or more parameters of the second instance, such as weighting coefficients and biases for one or more of the artificial neurons, until a known output data is given as an output from the second instance of the machine learning model when the corresponding known input data is given as an input to the second instance of the machine learning model. The know output data may be received from the wireless device 120, e.g. the result of the operation received in the information from the wireless device 120, or it may be stored in the network node 110, 130, 143. The known input data may be SNR values, Received Signal Strength Indicator (RSSI), control information transmitted over the control channel, speed, and other values related to the communication channel. More physical parameters such as location, orientation may be useful to predict beam-forming and/or beam-selection.

When the one or more parameters have been adjusted until the known output data is given as output from the second instance when the corresponding known input data is given as input to the second instance, the second instance of the machine learning model will be updated with these adjusted one or more parameters.

The network node 110, 130, 143 may also comprise means for storing data. In some embodiments, the network node 110, 130, 143 comprises a memory 306 configured to store the data. The data may be processed or non-processed data and/or information relating thereto. The information may relate to the machine learning model, such as the second instance of the machine learning model, information received from the wireless device 120, and information transmitted to the wireless device 120. The memory 306 may comprise one or more memory units. Further, the memory 306 may be a computer data storage or a semiconductor memory such as a computer memory, a read-only memory, a volatile memory or a non-volatile memory. The memory is arranged to be used to store obtained information, data, configurations, and applications etc. to perform the methods herein when being executed in the network node 110, 130, 143.

Embodiments herein for assisting the wireless device 120 in updating the first instance of the machine learning model may be implemented through one or more processors, such as the processor 307 in the arrangement depicted in FIG. 3, together with computer program code for performing the functions and/or method actions of embodiments herein. The program code mentioned above may also be provided as a computer program product, for instance in the form of a data carrier carrying computer program code for performing the embodiments herein when being loaded into the network node 110, 130, 143. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the network node 110, 130, 143.

Those skilled in the art will also appreciate that the input/output interface 301, the receiving unit 302, the transmitting unit 303, the determining unit 304, the updating unit 305, or one or more possible other units above may refer to a combination of analogue and digital circuits, and/or one or more processors configured with software and/or firmware, e.g. stored in the memory 306, that when executed by the one or more processors such as the processors in the network node 110, 130, 143 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SOC).

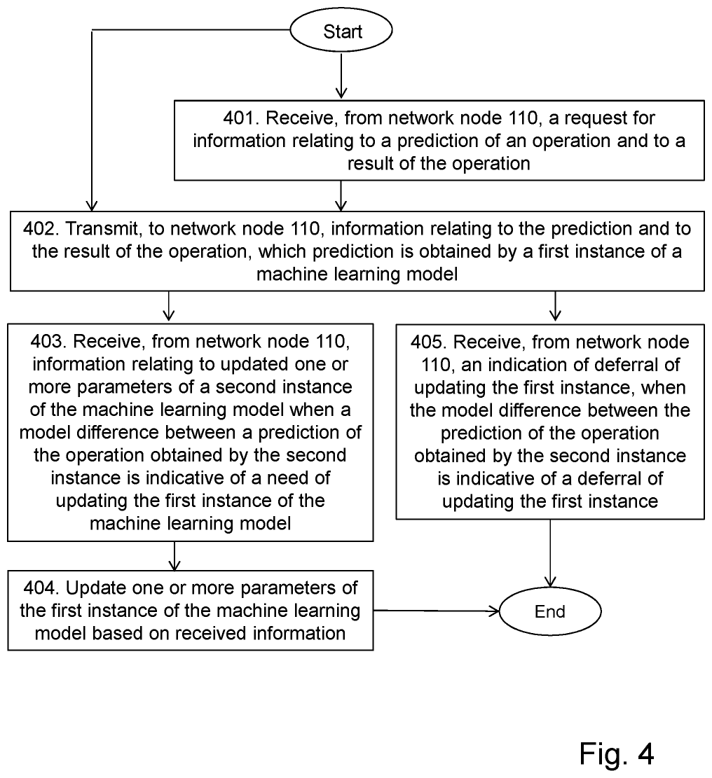

Examples of a method performed by the wireless device 120 for updating a first instance of a machine learning model relating to the wireless device 120 will now be described with reference to flowchart depicted in FIG. 4. As previously mentioned, the wireless device 120 and the network node 110, 130, 143 communicate over a communications interface in the wireless communications system 10. Further, the network node 110, 130, 143 has a second instance of the machine learning model. The machine leaning model relates to the wireless device 120. As previously mentioned, the machine learning model is a representation of the wireless device, one or more network nodes, e.g. the network node 110, 130, 143 operating in the communications system 10, and of one or more communications links between the wireless device 120 and the one or more network nodes. Further, the machine learning model may be a representation of one or more wireless devices, e.g. the wireless device 120, 122, and of one or more network nodes, e.g. the network node 110, 111, operating in the wireless communications system and of one or more communications links between the one or more wireless devices 10 and the one or more network nodes. As previously mentioned, the machine learning model may comprise an input layer, an output layer and one or more hidden layers, wherein each layer comprises one or more artificial neurons linked to one or more other artificial neurons of the same layer or of another layer; wherein each artificial neuron has an activation function, an input weighting coefficient, a bias and an output weighting coefficient, and wherein the weighting coefficients and the bias are changeable during training of the machine learning model.

The method comprises one or more of the following actions. It should be understood that these actions may be taken in any suitable order and that some actions may be combined.

Action 401

As previously described, in order to be able to perform remote machine learning, the network node 110, 130, 143 may transmit a request for information relating to a prediction of at least one operation of the wireless device 120 and of at least one result of the operation to the wireless device 120.

Thus, in some embodiments, the wireless device 120 receives, from the network node 110, 130, 143, a request for the information relating to the at least one prediction of the operation of the wireless device 120 and to the at least one result of the operation.

The wireless device 120 may receive the request when a period of time has expired, when a number of transmitted user communications is above a threshold value for the user communications, and/or when an error in the at least one prediction of the operation is expected by the network node 110, 130, 143.

Further, the network node 110, 130, 143 may transmit the request for the information when it expects that a change in performance of the wireless communications system 10 is significant, e.g. above a threshold value, and one or more parameters of the first and/or second instances may need to be updated. In other words, the network node 110, 130, 143 may transmit the request when system performance or other information indicates a significant difference in the prediction performance unless parameter update is performed. Thus, in such scenarios the wireless device 120 may receive the request.

Action 402

In order to enable the network node 110, 130, 143 to perform remote machine learning, the wireless device 120 transmits, to the network node 110, 130, 143, information relating to at least one prediction of an operation of the wireless device 120 and to at least one result of the operation. The at least one prediction of the operation is obtained by means of the first instance of the machine learning model. Further, the operation is relating to a transmission over the communications interface. For example, the operation may be a beam operation such as an operation to change transmit beam and/or receive beam for a transmission to be transmitted or received by the wireless device 120. As another example, the operation may be a handover operation or cell selection operation such as an operation to initiate a handover or a cell selection procedure. As a further example, the operation may be selection of modulation and coding scheme. As yet a further example, the operation may be a decision to defer the transmission until an improvement in SNR occurs or some timer expires.

As previously mentioned, the at least one prediction of the operation may be obtained or determined by the wireless device 120 by means of the first instance of the machine learning model. For example, the wireless device 120 may, e.g. by means of the machine learning unit 150, give as an input a known input data to the first instance of the machine learning model and use the output data from the first instance of the machine learning model as the prediction of the operation.

Further, the at least one result of the operation may be obtained or determined by the wireless device 120 by performing the operation.

As mentioned above, the wireless device 120 may receive, from the network node 110, 130, 143, a request for the information relating to the at least one prediction of the operation of the wireless device 120 and to the at least one result of the operation. In such embodiments, the wireless device 120 may transmit, to the network node 110, 130, 143, the information in response to the received request.

Action 403

In order to receive information relating to the remote machine learning, the wireless device 120 receives, from the network node 110, 130, 143, information relating to updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model. In some embodiments, the wireless device 120 receives, from the network node 110, 130, 143, the information relating to the updated one or more parameters from the network node 110, 130, 143 when the model difference is above a threshold value for the model difference.

The model difference being above the threshold value for the model difference may be indicative of a change in performance of the wireless communications system 10 being above a threshold value for the performance.

In some embodiments, the wireless device 120 receives the information relating to the updated one or more parameters when a load on a communications link between the network node 110, 130, 143 and the wireless device 120 is below a threshold value for the load.

It should be understood that the wireless device 120 may determine the training difference, i.e. the difference between the prediction of the operation and the result of the operation. Further, the wireless device 120 may store the determined training differences in a storage, e.g. in a memory 505, before transmitting them to the network node 110, 130, 143. Further, the determined training differences may be stored as accumulated training differences. Thereby, the storage space required for the storing may be reduced.

Action 404

The wireless device 120 updates one or more parameters of the first instance of the machine learning model based on the received information. By updating the first instance of the machine learning model based on the received information, a prediction of an operation made by the updated first instance of the machine learning model is the same as or almost the same as a result of the operation. Thus, the difference between the prediction of the operation and the actual result of the operation would be zero or at least small.

Action 405

In some embodiments, the wireless device 120 receives an indication of a deferral of updating the first instance of the machine learning model, when the model difference is indicative of a deferral of updating the first instance of the machine learning model.

The wireless device 120 may receive the indication of the deferral of updating the first instance of the machine learning model when the model difference is below the threshold value for the model difference.

AIternatively, the wireless device 120 may receive the indication of the deferral of updating the first instance of the machine learning model when the model difference is indicative of a change in performance of the wireless communications system 10 being below the performance threshold value.

This will inform the wireless device 120 that the first instance of the machine learning model is good and gives predictions of operations that are the same or almost the same as the results of the operations.

To perform the method for updating a first instance of a machine learning model, the network node 110, 130, 143 may be configured according to an arrangement depicted in FIG. 5. As previously mentioned, the wireless device 120 and the network node 110, 130, 143 communicate over a communications interface in the wireless communications system 10. Further, the network node 110, 130, 143 has a second instance of the machine learning model. The machine leaning model relates to the wireless device 120.

In some embodiments, the wireless device 120 comprises an input and/or output interface 501 configured to communicate with one or more other network nodes. The input and/or output interface 501 may comprise a wireless receiver (not shown) and a wireless transmitter (not shown).

The wireless device 120 is configured to receive, by means of a receiving unit 502 configured to receive, a transmission, e.g. a data packet, a signal or information, from another wireless device, e.g. the wireless device 120, from one or more network nodes, e.g. from the network node 110, and/or from one or more external node 141 and/or from one or more cloud node 143. The receiving unit 502 may be implemented by or arranged in communication with a processor 506 of the wireless device 120. The processor 506 will be described in more detail below.

As previously described, in order to be able to perform remote machine learning, the network node 110, 130, 143 may be configured to transmit a request for information relating to a prediction of at least one operation of the wireless device 120 and of at least one result of the operation to the wireless device 120. Thus, in some embodiments, the wireless device 120 is configured to receive, from the network node 110, 130, 143, a request for the information relating to the at least one prediction of the operation of the wireless device 120 and to the at least one result of the operation.

The wireless device 120 may be configured to receive the request when a period of time has expired, when a number of transmitted user communications is above a threshold value for the user communications, and/or when an error in the at least one prediction of the operation is expected by the network node 110, 130, 143.

Further, the network node 110, 130, 143 may transmit the request for the information when it expects that a change in performance of the wireless communications system 10 is significant, e.g. above a threshold value, and one or more parameters of the first and/or second instances may need to be updated. In other words, the network node 110, 130, 143 may transmit the request when system performance or other information indicates a significant difference in the prediction performance unless parameter update is performed. Thus, the wireless device 120 may be configured to receive the request in such scenarios.

In order to receive information relating to the remote machine learning, the wireless device 120 is configured to receive, from the network node 110, 130, 143, information relating to updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model.

In some embodiments, the wireless device 120 is configured to receive, from the network node 110, 130, 143, the information relating to the updated one or more parameters from the network node 110, 130, 143 when the model difference is above a threshold value for the model difference.

The model difference being above the threshold value for the model difference may be indicative of a change in performance of the wireless communications system 10 being above a threshold value for the performance.

In some embodiments, the wireless device 120 is configured to receive the information relating to the updated one or more parameters when a load on a communications link between the network node 110, 130, 143 and the wireless device 120 is below a threshold value for the load.

In some embodiments, the wireless device 120 is configured to receive an indication of a deferral of updating the first instance of the machine learning model, when the model difference is indicative of a deferral of updating the first instance of the machine learning model.

The wireless device 120 may be configured to receive the indication of the deferral of updating the first instance of the machine learning model when the model difference is below the threshold value for the model difference.

AIternatively, the wireless device 120 may be configured to receive the indication of the deferral of updating the first instance of the machine learning model when the model difference is indicative of a change in performance of the wireless communications system 10 being below the performance threshold value.

This will inform the wireless device 120 that the first instance of the machine learning model is good and gives predictions of operations that are the same or almost the same as the results of the operations.

The wireless device 120 is configured to transmit, by means of a transmitting unit 503 configured to transmit, a transmission, e.g. a data packet, a signal or information, to another wireless device, e.g. the wireless device 122, to one or more network nodes, e.g. to the network node 110 and/or to one or more external node 141 and/or to one or more cloud node 143. The transmitting unit 503 may be implemented by or arranged in communication with the processor 506 of the wireless device 120.

In order to enable the network node 110, 130, 143 to perform remote machine learning, the wireless device 120 is configured to transmit, to the network node 110, 130, 143, information relating to at least one prediction of an operation of the wireless device 120 and to at least one result of the operation. The at least one prediction of the operation is obtained by means of the first instance of the machine learning model. Further, the operation is relating to a transmission over the communications interface.

As previously mentioned, the at least one prediction of the operation may be obtained or determined by the wireless device 120 by means of the first instance of the machine learning model. For example, the wireless device 120 may, e.g. by means of the machine learning unit 150, configured to give as an input a known input data to the first instance of the machine learning model and use the output data from the first instance of the machine learning model as the prediction of the operation.

Further, the wireless device 120 is configured to obtain or determine the at least one result of the operation by performing the operation.

As mentioned above, the wireless device 120 may be configured to receive, from the network node 110, 130, 143, a request for the information relating to the at least one prediction of the operation of the wireless device 120 and to the at least one result of the operation. In such embodiments, the wireless device 120 may be configured to transmit, to the network node 110, 130, 143, the information in response to the received request.

The wireless device 120 is configured to update, by means of an updating unit 504 configured to update, one or more parameters of the second instance of the machine learning model. The updating module 504 may be implemented by or arranged in communication with the processor 506 of the wireless device 120.

The wireless device 120 is configured to update one or more parameters of the first instance of the machine learning model based on the received information. By updating the first instance of the machine learning model based on the received information, a prediction of an operation made by the updated first instance of the machine learning model is the same as or almost the same as a result of the operation. Thus, the difference between the prediction of the operation and the actual result of the operation would be zero or at least small.

The wireless device 120 may also comprise means for storing data. In some embodiments, the wireless device 120 comprises a memory 505 configured to store the data. The data may be processed or non-processed data and/or information relating thereto. The information may relate to the machine learning model, such as the second instance of the machine learning model, information received from the network node 110, 130, 143, and information transmitted to the network node 110, 130, 143. The memory 505 may comprise one or more memory units. Further, the memory 505 may be a computer data storage or a semiconductor memory such as a computer memory, a read-only memory, a volatile memory or a non-volatile memory. The memory is arranged to be used to store obtained information, data, configurations, and applications etc. to perform the methods herein when being executed in the wireless device 120.

Embodiments herein for updating the first instance of the machine learning model may be implemented through one or more processors, such as the processor 506 in the arrangement depicted in FIG. 5, together with computer program code for performing the functions and/or method actions of embodiments herein. The program code mentioned above may also be provided as a computer program product, for instance in the form of a data carrier carrying computer program code for performing the embodiments herein when being loaded into the wireless device 120. One such carrier may be in the form of an electronic signal, an optical signal, a radio signal or a computer readable storage medium. The computer readable storage medium may be a CD ROM disc or a memory stick.

The computer program code may furthermore be provided as program code stored on a server and downloaded to the wireless device 120.

Those skilled in the art will also appreciate that the input/output interface 501, the receiving unit 502, the transmitting unit 503, the updating unit 504, or one or more possible other units above may refer to a combination of analogue and digital circuits, and/or one or more processors configured with software and/or firmware, e.g. stored in the memory 505, that when executed by the one or more processors such as the processors in the wireless device 120 perform as described above. One or more of these processors, as well as the other digital hardware, may be included in a single Application-Specific Integrated Circuitry (ASIC), or several processors and various digital hardware may be distributed among several separate components, whether individually packaged or assembled into a System-on-a-Chip (SoC).

### Some Exemplifying Embodiments

Some exemplifying embodiments relating to actions and features described above will now be described in more detail.

In some exemplifying embodiments, the communications system 10 comprises a network node 110, 130, 143, e.g. an Access Point (AP) such as an eNB, and two wireless devices 120, 122 of different machine learning capabilities. The eNB is connected to a core network, e.g. the core network 102, and possibly a cloud infrastructure, such as a computer cloud 140. The wireless devices attached to the eNB may be of different machine learning capabilities, such as a first wireless device with capability for ML training, and a second wireless device with limited capability for ML training. A first wireless device, e.g. the wireless device 120, may be a smart phone with capability of ML training and a second wireless device, e.g. the wireless device 122, may be a connected temperature sensor with limited capabilities for ML training.

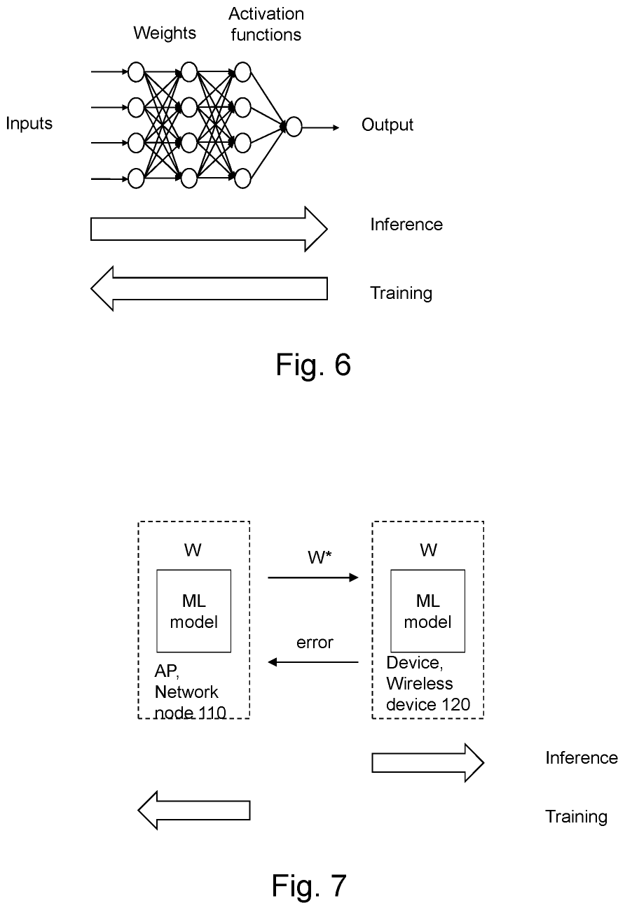

FIG. 6 schematically illustrates an example machine learning model as a neural network. Normally, if the machine learning model is trained, the inference phase, i.e. the forward pass, and the training phase, i.e. the backward pass, is performed at the same location, e.g. in a network node or in a wireless device.

FIG. 7 schematically illustrates the separation of the inference phase and training phase to different network entities, i.e. to different network nodes and/or wireless devices. The inference is performed at the wireless device, e.g. the wireless device 120, to predict some parameter, e.g., one or more parameters of an operation relating to a transmission over a communications interface such as relating to the user communication or common functions. Parameters of the machine learning model are represented by the variable W in FIG. 7. The variable W may be a weight in a neural network or relating to one or decision conditions in a tree model or similar. The wireless device 120 uses a first instance of the machine learning model with parameters W to predict the output. During training, either initial training or training taking place during use, the output of the machine learning model is compared to a known true result. The machine learning model may perform either classification or regression. The difference, sometimes referred to as error, e, if any, in the output is computed and either stored for each training example or stored as an accumulated error. The wireless device 120 may compute and store the differences. Further, at some point in time the wireless device 120 may transmit the differences to the network node.

In the case of accumulated errors, the following formulas are used to compute the mean error. If useful for the training, variance and higher moments may be computed in similar way. This may be performed by the wireless device 120.

Initiate the training example counter n and the error mean m to zero.
n=n+1 For each new training example error e, update the example counter n
δ=e−m Let δ be the difference between the current error value e and the current accumulated error mean
m′=m+δ/n Update the error mean value

The collected error values or the accumulated error mean is then transmitted, by the wireless device 120, to the network node 110, 130, 143, e.g. the AP such as the eNB or a gNB, where the ML model is updated. The updated ML model parameters W* are then transmitted to the wireless device 120 from the network node 110, 130, 143 and used, by the wireless device 120, in a forthcoming inference phase to make a new prediction of an operation.

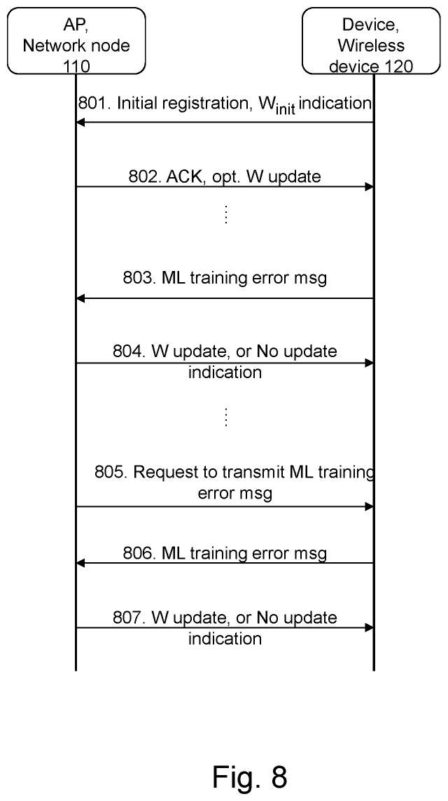

FIG. 8 is a combined flowchart and signalling scheme schematically illustrating embodiments of a method performed in a wireless communications system. Thus it gives an example of message exchange between the wireless device 120 and the network node 110, 130, 143 such as the AP, e.g. the eNB. User communication is not shown in the figure. At an initial registration with the network node 110, 130, 143, herein sometimes denoted eNB, Access Point (AP), the wireless device 120 indicates to the network node 110, 130, 143 which ML model parameters the wireless device 120 has or has access to, cf. Action 801. This may either be the actual parameters or some index. If a repository of ML models and indices is kept at some central network node, e.g. at a core network node, an external node, or at a cloud network node, the amount of transmission of ML model parameters may be reduced and only indices transmitted. Upon acknowledging the wireless device 120, the network node 100 may transmit updated ML model parameters W and a corresponding index, cf. Action 802.

After some time, the wireless device 120 transmits the ML training errors to the network node 110, 130, 143, cf. Action 803. The AP receives the errors, updates in Action 804 the ML model, and determines if an updated version of W should be transmitted to e.g. the wireless device. If the updates to the ML model parameters are too small to merit transmission, a “no update indication” is sent to the wireless device 120, cf. Action 804. However, the updated instance of the model is kept in the network node 110, 130, 143 and subsequent ML model updates are performed by the network node 110, 130, 143 on the most current instance of the ML model. When eventually the updates are sufficiently different compared to the first instance of the ML model in the wireless device 120, the updated W, sometimes in this disclosure referred to as W*, is transmitted to the wireless device 120, cf. Action 804.

The network node 110, 130, 143 may also trigger the transmission of ML training errors, cf. Action 805. If the network node 110, 130, 143 collects error data from multiple wireless devices, such as sensors in similar circumstances, e.g. similar location, capabilities, traffic, etc., the network node 110, 130, 143 may trigger a transmission from multiple wireless devices and update a common model based on the collective error messages from all wireless devices such as from all sensors, cf. Action 806. The updated model W may then be transmitted to the wireless devices where the updates are sufficiently large, cf. Action 807. Updates may of course always be transmitted but this increases the ML traffic load in the communications system 10 which competes with the user communication and costs resources at the wireless device.

The “update” and “no update” indications transmitted from the network node 110, 130, 143 to the wireless device 120 may also depend on ongoing traffic over a communications link between the network node 110, 130, 143 and the wireless device 120. These types of update indications may be transmitted at opportune moments in order not to disturb the ongoing traffic over the communications link. For example, a model update may not necessarily be required because the original ML model and the updated ML model are not sufficiently different, but still it may be advantageous to update the ML model since it may not be possible to update the ML model for a long period of time due to heavy traffic. Similarly, a transmission of an update indication may be deferred to a later moment if the traffic load is high and the model update is minor.

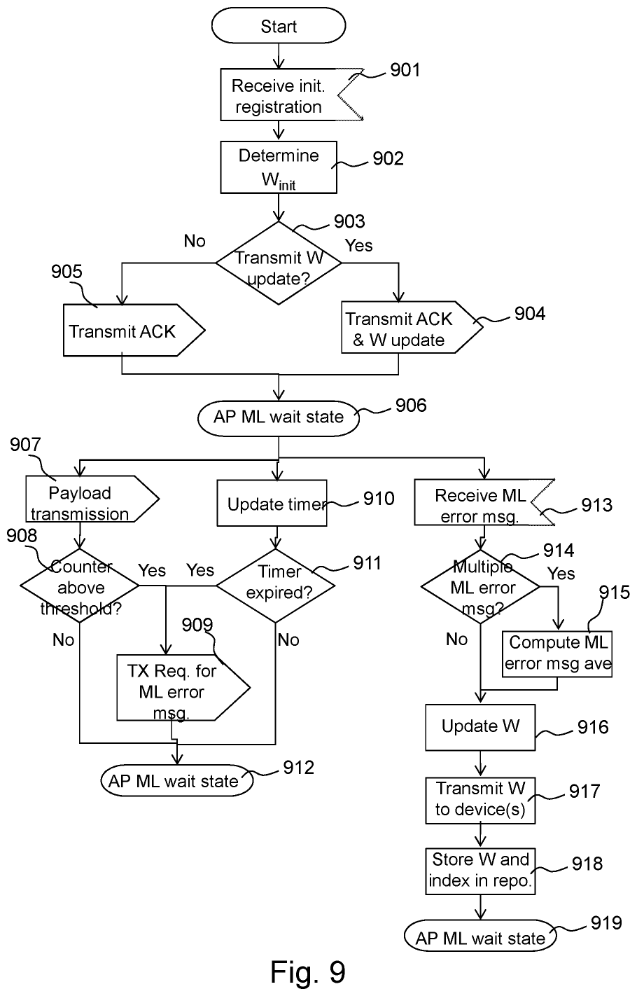

FIG. 9 is a flowchart depicting embodiments of a method performed by the network node 110, 130, 143, e.g. the AP. The top part, cf. Actions 901-905, shows the initial registration of the wireless device 120, as described above in relation to Actions 801-804. After the initial registration, the ML model handling for that particular wireless device 120 enters a wait state, cf. Action 906. However, other actions not relating to the ML model handling are assumed to be performed in the meantime, including user communication.

The network node 110, 130, 143 may leave its wait state when a sufficient number of payload transmissions have occurred, cf. Actions 907-909, and 912, when an ML training error message is received from the wireless device 120, cf. Actions 913-919, or when a timer expires, e.g. when a predefined or predetermined time period expires, cf. Actions 910, 911, 909 and 912. Other relevant events may be considered as well.

In the case of timer expiration or after occurrence of the sufficient number of payload transmissions, the network node 110, 130, 143 may in Action 909 trigger a request for ML model errors to be transmitted from the wireless device 120 or from multiple wireless devices to the network node 110, 130, 143. When multiple ML error messages are received by the network node 110, 130, 143, cf. Actions 914 and 915, they are first averaged before the ML model parameters W are updated. The updated W is transmitted to the one or more wireless device(s) 120 if the difference is sufficiently large, cf. Action 917. The updated W and a corresponding index may also be stored in a repository in the communications system 10 to reduce the system-wide ML update computation and parameter transmission load.

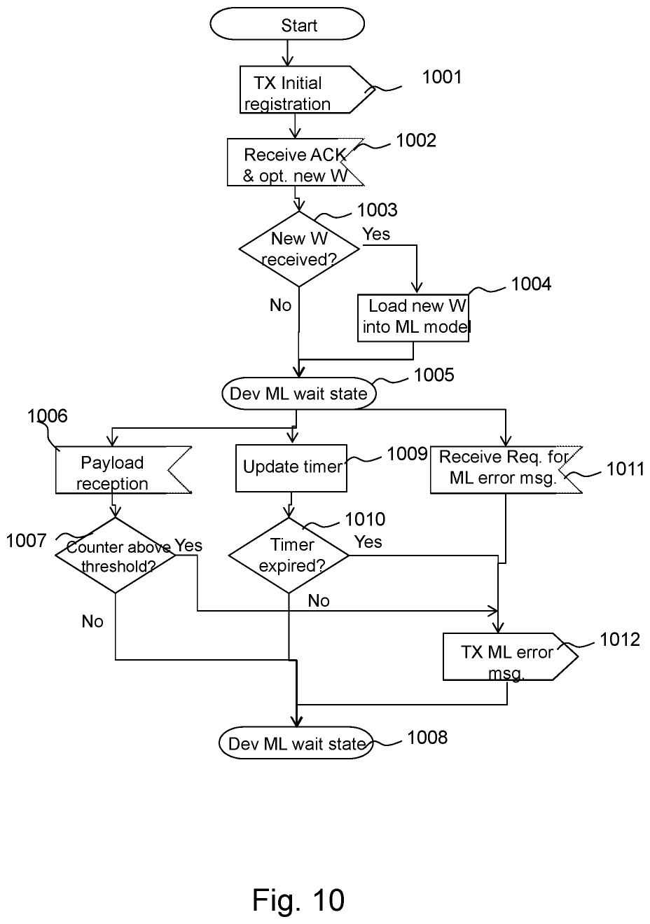

FIG. 10 is a flowchart depicting embodiments of a method performed by the wireless device 120. Here no ML training occurs. The actual computation of the ML training error is not shown in the flowchart. However, the wireless device 120 may be triggered, by the network node 110, 130, 143, to perform the computation of the training error. The wireless device 120 may be triggered to perform the computation by the user communications transmission or by specific training transmissions. For example, the network node 110, 130, 143 may trigger the wireless device 120 by transmitting pilots and/or reference symbols to the wireless device 120.

In Action 1001, the wireless device 120 performs the initial registration with the network node 110, 130, 143, wherein the wireless device 120 transmits the information relating to the prediction of the operation of the wireless device 120 and to the result of the operation. The wireless deice 120 receives, in Action 1002, an acknowledgement and possibly also updated parameters W to be used in updating the first instance of the machine learning model. If the new parameters W are received the first instance of the machine learning model is updated with them, cf. Actions 1003 and 1004. Then, the wireless device 120 may enter a wait state, cf. Action 1005. However, other actions not relating to the ML model handling such as user communications are assumed to be performed in the meantime.

The wireless device 120 may leave its wait state when a sufficient number of payload transmissions have occurred, cf. Actions 1006-1008, when a request for a ML error, e.g. for information relating to a prediction of an operation and to a result of the operation, is received from the network node 110, 130, 143, cf. Actions 1011-1012, or when a timer expires, e.g. when a predefined or predetermined time period expires, cf.

Actions 1009-1010. Other relevant events may be considered as well.

In the case of timer expiration or after occurrence of the sufficient number of payload transmissions, the wireless device 120 may in Action 1012 transmit ML model errors to the network node 110, 130, 143.

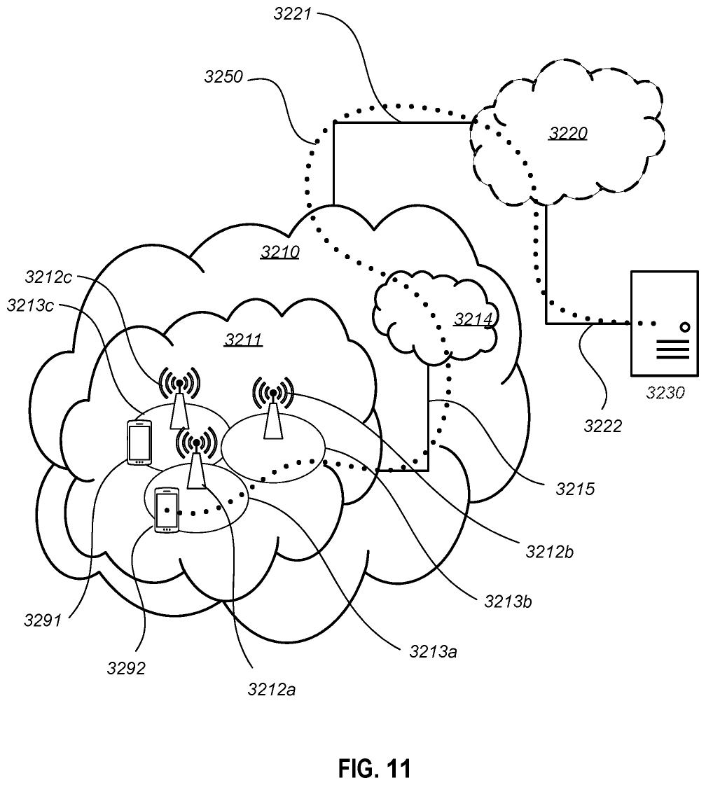

Further Extensions and Variations With reference to FIG. 11, in accordance with an embodiment, a communication system includes a telecommunication network 3210 such as the wireless communications network 100, e.g. a WLAN, such as a 3GPP-type cellular network, which comprises an access network 3211, such as a radio access network, e.g. the RAN 101, and a core network 3214, e.g. the CN 102. The access network 3211 comprises a plurality of base stations 3212a, 3212b, 3212c, such as the network node 110, 111, access nodes, AP STAs NBs, eNBs, gNBs or other types of wireless access points, each defining a corresponding coverage area 3213a, 3213b, 3213c. Each base station 3212a, 3212b, 3212c is connectable to the core network 3214 over a wired or wireless connection 3215. A first user equipment (UE) e.g. the wireless device 120, 122 such as a Non-AP STA 3291 located in coverage area 3213c is configured to wirelessly connect to, or be paged by, the corresponding base station 3212c. A second UE 3292 e.g. the wireless device 122 such as a Non-AP STA in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220, e.g. the external network 200. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 11 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

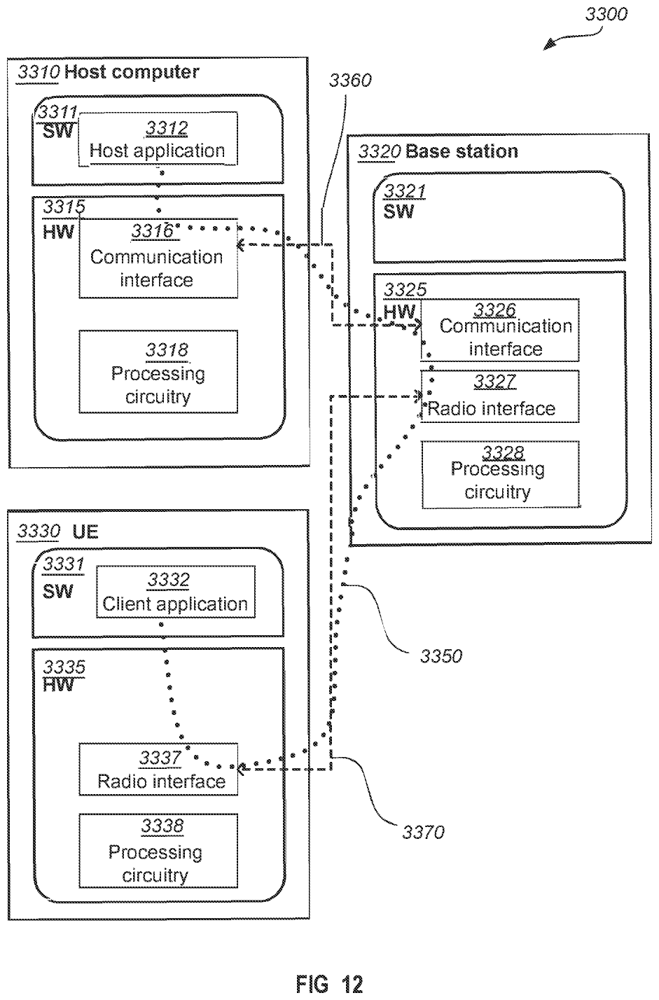

Example implementations, in accordance with an embodiment, of the UE, base station and host computer discussed in the preceding paragraphs will now be described with reference to FIG. 12. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 12) served by the base station 3320. The communication interface 3326 may be configured to facilitate a connection 3360 to the host computer 3310. The connection 3360 may be direct or it may pass through a core network (not shown in FIG. 12) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 12 may be identical to the host computer 3230, one of the base stations 3212a, 3212b, 3212c and one of the UEs 3291, 3292 of FIG. 11, respectively. This is to say, the inner workings of these entities may be as shown in FIG. 12 and independently, the surrounding network topology may be that of FIG. 11.

In FIG. 12, the OTT connection 3350 has been drawn abstractly to illustrate the communication between the host computer 3310 and the use equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may reduce the signalling overhead and thus improve the data rate. Thereby, providing benefits such as reduced user waiting time, relaxed restriction on file size, and/or better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signalling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

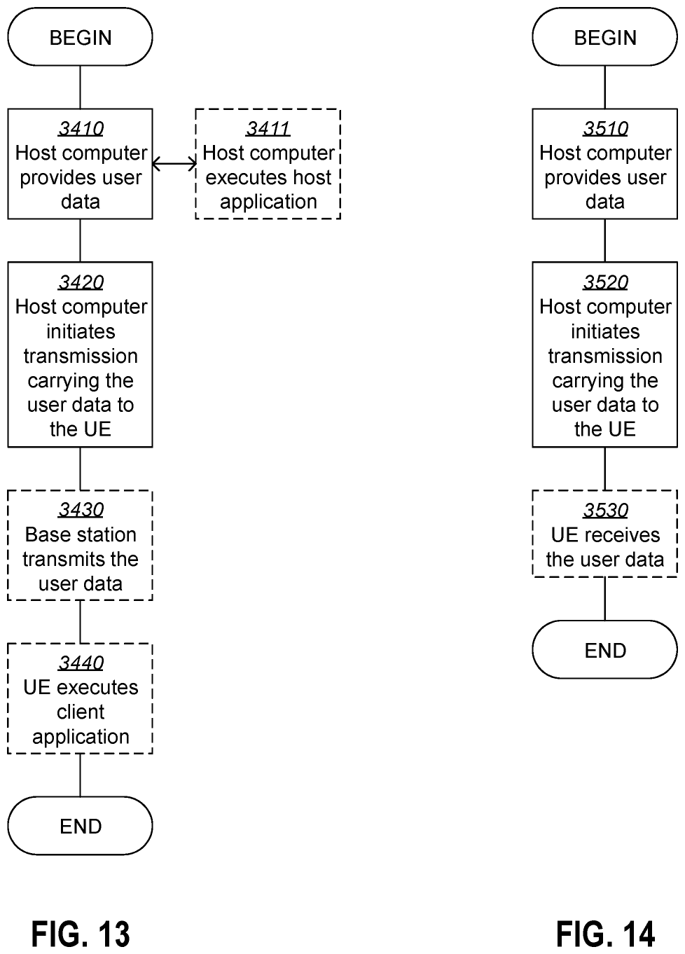

FIG. 13 is a flowchart illustrating a method implemented in a communication system, in accordance with one embodiment. The communication system includes a host computer, a base station such as an AP STA, and a UE such as a Non-AP STA which may be those described with reference to FIGS. 11 and 12. For simplicity of the present disclosure, only drawing references to FIG. 13 will be included in this section. In a first action 3410 of the method, the host computer provides user data. In an optional subaction 3411 of the first action 3410, the host computer provides the user data by executing a host application. In a second action 3420, the host computer initiates a transmission carrying the user data to the UE. In an optional third action 3430, the base station transmits to the UE the user data which was carried in the transmission that the host computer initiated, in accordance with the teachings of the embodiments described throughout this disclosure. In an optional fourth action 3440, the UE executes a client application associated with the host application executed by the host computer.

FIG. 14 is a flowchart illustrating a method implemented in a communication system, in accordance with one embodiment. The communication system includes a host computer, a base station such as an AP STA, and a UE such as a Non-AP STA which may be those described with reference to FIGS. 11 and 12. For simplicity of the present disclosure, only drawing references to FIG. 13 will be included in this section. In a first action 3510 of the method, the host computer provides user data. In an optional subaction (not shown) the host computer provides the user data by executing a host application. In a second action 3520, the host computer initiates a transmission carrying the user data to the UE. The transmission may pass via the base station, in accordance with the teachings of the embodiments described throughout this disclosure. In an optional third action 3530, the UE receives the user data carried in the transmission.

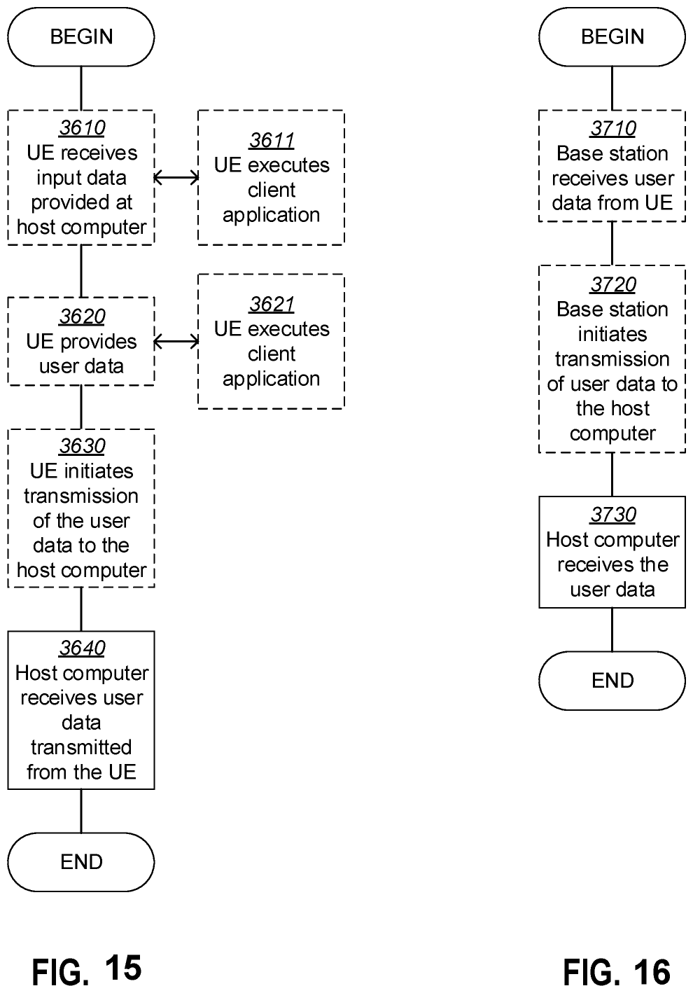

FIG. 15 is a flowchart illustrating a method implemented in a communication system, in accordance with one embodiment. The communication system includes a host computer, a base station such as a AP STA, and a UE such as a Non-AP STA which may be those described with reference to FIGS. 11 and 12. For simplicity of the present disclosure, only drawing references to FIG. 15 will be included in this section. In an optional first action 3610 of the method, the UE receives input data provided by the host computer. Additionally or alternatively, in an optional second action 3620, the UE provides user data. In an optional subaction 3621 of the second action 3620, the UE provides the user data by executing a client application. In a further optional subaction 3611 of the first action 3610, the UE executes a client application which provides the user data in reaction to the received input data provided by the host computer. In providing the user data, the executed client application may further consider user input received from the user. Regardless of the specific manner in which the user data was provided, the UE initiates, in an optional third subaction 3630, transmission of the user data to the host computer. In a fourth action 3640 of the method, the host computer receives the user data transmitted from the UE, in accordance with the teachings of the embodiments described throughout this disclosure.

FIG. 16 is a flowchart illustrating a method implemented in a communication system, in accordance with one embodiment. The communication system includes a host computer, a base station such as a AP STA, and a UE such as a Non-AP STA which may be those described with reference to FIGS. 12 and 13. For simplicity of the present disclosure, only drawing references to FIG. 16 will be included in this section. In an optional first action 3710 of the method, in accordance with the teachings of the embodiments described throughout this disclosure, the base station receives user data from the UE. In an optional second action 3720, the base station initiates transmission of the received user data to the host computer. In a third action 3730, the host computer receives the user data carried in the transmission initiated by the base station.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Abbreviation Explanation
AI Artificial Intelligence
AP Access Point
BS Base Station
eNB Enhance Node B
Fcn Function
HW Hardware
MI Machine Intelligence
ML Machine Learning
RF Radio Frequency
UE User Equipment

1. A method performed in a network node for assisting a wireless device in updating a first instance of a machine learning model relating to the wireless device, the network node and the wireless device communicating over a communications interface in a wireless communications system, the network node having a second instance of the machine learning model relating to the wireless device, and the method comprising:
receiving, from the wireless device, information relating to at least one prediction of an operation of the wireless device and to at least one result of the operation, which at least one prediction of the operation is obtained by means of the first instance of the machine learning model; and which operation is relating to a transmission over the communications interface;
updating one or more parameters of the second instance of the machine learning model based on the received information;
transmitting, to the wireless device, information relating to the updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model.

2. The method of claim 1, comprising:
based on the received information relating to the at least one prediction of the operation of the wireless device and to the at least one result of the operation, determining a training difference between the at least one prediction of the operation of the wireless device and the at least one result of the operation; and wherein the updating of the one or more parameters of the second instance of the machine learning model comprises:
updating the one or more parameters of the second instance of the machine learning model based on the determined training difference.

3. The method of claim 1, wherein the transmitting of the information relating to the updated one or more parameters to the wireless device when the model difference is indicative of the need of updating the first instance of the machine learning model comprises:
transmitting the information relating to the updated one or more parameters to the wireless device when the determined model difference is above a threshold value for the model difference.

4. The method of claim 3, wherein the model difference being above the model difference threshold value is indicative of a change in performance of the wireless communications system being above a threshold value for the performance.

5. The method of claim 1, wherein the transmitting of the information relating to the updated one or more parameters comprises:
transmitting, to the wireless device, the information relating to the updated one or more parameters when a load on a communications link between the network node and the wireless device is below a threshold value for the load.

6. The method of claim 1, further comprising:
transmitting, to the wireless device, an indication of a deferral of updating the first instance of the machine learning model, when the model difference is indicative of a deferral of updating the first instance of the machine learning model.

7. The method of claim 6, wherein the transmitting of the indication of a deferral of updating the first instance of the machine learning model when the model difference is indicative of a deferral of updating the first instance of the machine learning model comprises any one out of:
transmitting the indication of a deferral of updating the first instance of the machine learning model when the determined model difference is below the threshold value for the model difference; and
transmitting the indication of a deferral of updating the first instance of the machine learning model when the model difference is indicative of a change in performance of the wireless communications system being below the threshold value for the performance.

8. The method of claim 1, further comprising:
transmitting, to the wireless device, a request for the information relating to the at least one prediction of the operation of the wireless device and to the at least one result of the operation, and wherein the receiving, from the wireless device, of the information relating to the at least one prediction of the operation of the wireless device and to the at least one result of the operation comprises:
receiving, from the wireless device, the information in response to the transmitted request.

9. The method of claim 8, wherein the transmitting of the request further comprises at least one of:
transmitting the request when a period of time has expired;
transmitting the request when a number of received user communications from the wireless device is above a threshold value for the user communications; and
transmitting the request when an error in the at least one prediction of the operation is expected.

10. A method performed in a wireless device for updating a first instance of a machine learning model relating to the wireless device, the wireless device and a network node having a second instance of the machine learning model relating to the wireless device are communicating over a communications interface in a wireless communications system, the method comprising:
transmitting, to the network node, information relating to at least one prediction of an operation of the wireless device and to at least one result of the operation, which at least one prediction of the operation is obtained by means of the first instance of the machine learning model; and which operation is relating to a transmission over the communications interface;
receiving, from the network node, information relating to updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model; and
updating one or more parameters of the first instance of the machine learning model based on the received information.

11. The method of claim 10, wherein the receiving, from the network node, of the information relating to the updated one or more parameters when the model difference is indicative of the need of updating the first instance of the machine learning model comprises:
receiving the information relating to the updated one or more parameters from the network node when the model difference is above a threshold value for the model difference.

12. The method of claim 11, wherein the model difference being above the model difference threshold value is indicative of a change in performance of the wireless communications system being above a threshold value for the performance.

13. The method of claim 10, wherein the receiving of the information relating to the updated one or more parameters comprises:
receiving, from the network node, the information relating to the updated one or more parameters when a load on a communications link between the network node and the wireless device is below a threshold value for the load.

14. The method of claim 10, further comprising:
receiving, from the network node, an indication of a deferral of updating the first instance of the machine learning model, when the model difference is indicative of a deferral of updating the first instance of the machine learning model.

15. The method of claim 14, wherein the receiving of the indication of the deferral of updating the first instance of the machine learning model when the model difference is indicative of a deferral of updating the first instance of the machine learning model comprises any one out of:
receiving the indication of the deferral of updating the first instance of the machine learning model when the model difference is below the threshold value for the model difference; and
receiving the indication of the deferral of updating the first instance of the machine learning model when the model difference is indicative of a change in performance of the wireless communications system being below the performance threshold value.

16. The method of claim 10, further comprising:
receiving, from the network node, a request for the information relating to the at least one prediction of the operation of the wireless device and to the at least one result of the operation, and wherein the transmitting, to the network node, of the information relating to the at least one prediction of the operation of the wireless device and to the at least one result of the operation comprises:
transmitting, to the network node, the information in response to the received request.

17. The method of claim 16, wherein the receiving of the request further comprises at least one of:
receiving the request when a period of time has expired;
receiving the request when a number of transmitted user communications is above a threshold value for the user communications;
receiving the request when an error in the at least one prediction of the operation is expected by the network node.

18. A network node for assisting a wireless device in updating a first instance of a machine learning model relating to the wireless device, the network node and the wireless device configured to communicate over a communications interface in a wireless communications system, the network node configured to have a second instance of the machine learning model relating to the wireless device, and the network node being configured to:
receive, from the wireless device, information relating to at least one prediction of an operation of the wireless device and to at least one result of the operation, which at least one prediction of the operation is obtained by means of the first instance of the machine learning model; and which operation is relating to a transmission over the communications interface;
update one or more parameters of the second instance of the machine learning model based on the received information;
transmit, to the wireless device, information relating to the updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model.

19. The network node of claim 18, further configured to:
determine a training difference between the at least one prediction of the operation of the wireless device and the at least one result of the operation based on the received information relating to the at least one prediction of the operation of the wireless device and to the at least one result of the operation; and wherein the network node is configured to update the one or more parameters of the second instance of the machine learning model by further being configured to:
update the one or more parameters of the second instance of the machine learning model based on the determined training difference.

20-26. (canceled)

27. A wireless device for updating a first instance of a machine learning model relating to the wireless device, the wireless device and a network node configured to have a second instance of the machine learning model relating to the wireless device are configured to communicate over a communications interface in a wireless communications system, the wireless device being configured to:
transmit, to the network node, information relating to at least one prediction of an operation of the wireless device and to at least one result of the operation, which at least one prediction of the operation is obtained by means of the first instance of the machine learning model; and which operation is relating to a transmission over the communications interface;
receive, from the network node, information relating to updated one or more parameters of the second instance of the machine learning model when a model difference between a prediction of the operation obtained by the second instance of the machine learning model comprising the updated one or more parameters and the prediction of the operation obtained by means of the first instance of the machine learning model is indicative of a need of updating the first instance of the machine learning model; and
update one or more parameters of the first instance of the machine learning model based on the received information.

28.-36. (canceled)
